(19) United States
(12) Patent Application Publication
(10) Pub. No.: US 2016/0205263 A1
(43) Pub. Date: Jul. 14, 2016

(54) Echo Cancellation Method and Apparatus

(71) Applicant: Huawei Technologies Co., Ltd., Shenzhen (CN)

(72) Inventors: Yuanyuan Liu, Shenzhen (CN); Deming Zhang, Shenzhen (CN)

(21) Appl. No.: 15/078,587

(22) Filed: Mar. 23, 2016

Related U.S. Application Data
(63) Continuation of application No. PCT/CN2014/074668, filed on Apr. 2, 2014.

(30) Foreign Application Priority Data
Sep. 27, 2013 (CN) 201310449391.0

(51) Int. Cl. H04M 9/08

(52) U.S. Cl. CPC H04M 9/082

(57) ABSTRACT

An echo cancellation method and apparatus, where the method includes collecting, by a collection microphone, a sound signal, collecting, by a conversation microphone, a near-end speech signal, canceling an echo component in the near-end speech signal according to the sound signal, to generate an echo-canceled speech signal, and outputting the echo-canceled speech signal such that the echo cancellation effect may be improved and conversation quality may be enhanced.

### CROSS-REFERENCE TO RELATED APPLICATIONS

This application is a continuation of International Application No. PCT/CN2014/074668, filed on Apr. 2, 2014, which claims priority to Chinese Patent Application No. 201310449391.0, filed on Sep. 27, 2013, both of which are hereby incorporated by reference in their entireties.

### TECHNICAL FIELD

The present disclosure relates to the field of electronic technologies, and in particular, to an echo cancellation method and apparatus.

### BACKGROUND

A communication device such as a mobile terminal is usually subject to echo interference in a conversation process, where the echo interference may include echo interference received by a microphone from a loudspeaker, and the like. The echo interference may directly affect conversation quality. Therefore, the prior art puts forward an echo cancellation solution. In a communication process, a far-end speech signal sent to a loudspeaker is used as reference, and an echo cancellation operation is performed on a near-end speech signal.

When factors such as a signal collected by a microphone is saturated due to an extremely loud loudspeaker sound of a communication device, and a play effect difference caused by a limitation of software or hardware of a loudspeaker appears, excessive nonlinear components are introduced to a near-end speech signal. In this case, in the prior art, echo interference cannot be effectively canceled.

### SUMMARY

Embodiments of the present disclosure provide an echo cancellation method and apparatus, to resolve a problem in the prior art that echo interference cannot be effectively canceled when a signal collection saturation phenomenon appears in a conversation microphone and a play effect difference exists in a loudspeaker such that an echo cancellation effect can be improved and conversation quality can be enhanced.

To resolve the foregoing technical problem, according to a first aspect, an embodiment of the present disclosure provides an echo cancellation method, where the method includes collecting, by a collection microphone, a sound signal, collecting, by a conversation microphone, a near-end speech signal, canceling an echo component in the near-end speech signal according to the sound signal, to generate an echo-canceled speech signal, and outputting the echo-canceled speech signal.

With reference to the first aspect, in a first possible implementation manner, the collection microphone is a unidirectional collection microphone, and the unidirectional collection microphone points to a loudspeaker direction.

With reference to the first aspect, in a second possible implementation manner, the collection microphone includes at least two collection sub-microphones, where the collection sub-microphones are omnidirectional collection microphones, and the omnidirectional collection microphones are arranged in an array manner.

With reference to the first aspect, in a third possible implementation manner, the collection microphone includes at least two collection sub-microphones, and the collecting, by a collection microphone, a sound signal includes acquiring a near-end sound source position, and selecting, from all the collection sub-microphones, a collection sub-microphone closest to the near-end sound source position, to collect the sound signal, where the collection sub-microphone closest to the near-end sound source position is a unidirectional collection microphone or an omnidirectional collection microphone.

With reference to the first aspect, in a fourth possible implementation manner, the collection microphone is a unidirectional microphone, and the canceling an echo component in the near-end speech signal according to the sound signal, to generate an echo-canceled speech signal includes performing, by a filter, analog on the echo component in the near-end speech signal according to the sound signal, to generate an analog echo signal, and canceling the echo component in the near-end speech signal using the analog echo signal, to generate the echo-canceled speech signal.

With reference to the first aspect, in a fifth possible implementation manner, the collection microphone is an omnidirectional collection microphone, and the canceling an echo component in the near-end speech signal according to the sound signal, to generate an echo-canceled speech signal includes performing a beamforming calculation on the sound signal to generate a sound signal of a specified direction, where the sound signal of the specified direction points to a loudspeaker direction, performing, by a filter, analog on the echo component in the near-end speech signal according to the sound signal of the specified direction, to generate an analog echo signal, and canceling the echo component in the near-end speech signal according to the analog echo signal, to generate the echo-canceled speech signal.

With reference to the first aspect, in a sixth possible implementation manner, at least two echo-canceled speech signals are generated, and the outputting the echo-canceled speech signal includes acquiring a residual echo amount of each of the echo-canceled speech signals, selecting, according to the acquired residual echo amounts of the echo-canceled speech signals, a speech signal that includes a minimum residual echo amount from the echo-canceled speech signals, and outputting the speech signal that includes the minimum residual echo amount.

With reference to the first aspect, in a seventh possible implementation manner, after the collecting, by a collection microphone, a sound signal, the method further includes acquiring a far-end speech signal, where the far-end speech signal is a signal received from a communication peer end, and canceling the echo component in the near-end speech signal using the far-end speech signal, to generate a speech signal processed using the far-end speech signal, and correspondingly, after the outputting the echo-canceled speech signal, the method further includes inputting the echo-canceled speech signal and the speech signal processed using the far-end speech signal into a comparator, acquiring, by the comparator, a residual echo amount of the echo-canceled speech signal and a residual echo amount of the speech signal processed using the far-end speech signal, selecting, according to the acquired residual echo amount of the echo-canceled speech signal and the acquired residual echo amount of the speech signal processed using the far-end speech signal, a speech signal that includes a minimum residual echo amount from the echo-canceled speech signal and the speech signal processed using the far-end speech signal, and outputting the speech signal that includes the minimum residual echo amount.

With reference to the seventh possible implementation manner of the first aspect, in an eighth possible implementation manner of the first aspect, the outputting the speech signal that includes the minimum residual echo amount includes detecting whether the near-end speech signal exceeds a specified sound pickup frequency range of the conversation microphone; if it is detected that the near-end speech signal exceeds the specified sound pickup frequency range of the conversation microphone, determining whether the speech signal that includes the minimum residual echo amount is the speech signal processed using the far-end speech signal; if it is determined that the speech signal that includes the minimum residual echo amount is the speech signal processed using the far-end speech signal, stopping, by the comparator, outputting the speech signal that includes the minimum residual echo amount, and selecting the echo-canceled speech signal as a specified output speech signal, and outputting the specified output speech signal.

Correspondingly, according to a second aspect, an embodiment of the present disclosure further provides a communication device, including a first collection module configured to collect a sound signal using a collection microphone, a second collection module configured to collect a near-end speech signal using a conversation microphone, a cancellation module configured to cancel, according to the sound signal collected by the first collection module, an echo component in the near-end speech signal collected by the second collection module, to generate an echo-canceled speech signal, and an output module configured to output the echo-canceled speech signal generated by the cancellation module.

With reference to the second aspect, in a first possible implementation manner, the collection microphone is a unidirectional collection microphone, and the unidirectional collection microphone points to a loudspeaker direction.

With reference to the second aspect, in a second possible implementation manner, the collection microphone includes at least two collection sub-microphones, where the collection sub-microphones are omnidirectional collection microphones, and the omnidirectional collection microphones are arranged in an array manner.

With reference to the second aspect, in a third possible implementation manner, the collection microphone includes at least two collection sub-microphones, and the first collection module includes a first acquiring unit configured to acquire a near-end sound source position, a first selection unit configured to select, from all the collection sub-microphones, a collection sub-microphone closest to the near-end sound source position acquired by the first acquiring unit; and a first collection unit configured to collect the sound signal using the collection sub-microphone selected by the first selection unit, where the collection sub-microphone closest to the near-end sound source position is a unidirectional collection microphone or an omnidirectional collection microphone.

With reference to the second aspect, in a fourth possible implementation manner, the collection microphone is a unidirectional microphone, and the cancellation module includes a first analog unit configured to perform analog on the echo component in the near-end speech signal using a filter according to the sound signal collected by the first collection module, to generate an analog echo signal, and a first cancellation unit configured to cancel the echo component in the near-end speech signal using the analog echo signal generated by the first analog unit, to generate the echo-canceled speech signal.

With reference to the second aspect, in a fifth possible implementation manner, the collection microphone is an omnidirectional collection microphone, and the cancellation module includes a first calculation unit configured to perform a beamforming calculation on the sound signal collected by the first collection module, to generate a sound signal of a specified direction, where the sound signal of the specified direction points to a loudspeaker direction, a second analog unit configured to perform analog on the echo component in the near-end speech signal using a filter according to the sound signal that is of the specified direction and is generated by the first calculation unit, to generate an analog echo signal, and a second cancellation unit configured to cancel the echo component in the near-end speech signal according to the analog echo signal generated by the second analog unit, to generate the echo-canceled speech signal.

With reference to the second aspect, in a sixth possible implementation manner, the cancellation module generates at least two echo-canceled speech signals, and the output module includes a second acquiring unit configured to acquire a residual echo amount of each of the echo-canceled speech signals, a second selection unit configured to select, according to the residual echo amounts that are of the echo-canceled speech signals and are acquired by the second acquiring unit, a speech signal that includes a minimum residual echo amount from the echo-canceled speech signals, and a first output unit configured to output the speech signal that includes the minimum residual echo amount and is selected by the second selection unit.

With reference to the second aspect, in a seventh possible implementation manner, the communication device further includes an acquiring module configured to acquire a far-end speech signal, where the far-end speech signal is a signal received from a communication peer end, where the cancellation module is further configured to cancel the echo component in the near-end speech signal using the far-end speech signal acquired by the acquiring module, to generate a speech signal processed using the far-end speech signal, and an input module configured to input the echo-canceled speech signal and the speech signal processed using the far-end speech signal into a comparator, where the output module includes a third acquiring unit configured to acquire, using the comparator, a residual echo amount of the echo-canceled speech signal and a residual echo amount of the speech signal processed using the far-end speech signal, a third selection unit configured to select, according to the residual echo amount that is of the echo-canceled speech signal and is acquired by the third acquiring unit and the residual echo amount that is of the speech signal processed using the far-end speech signal and is acquired by the third acquiring unit, a speech signal that includes a minimum residual echo amount from the echo-canceled speech signal and the speech signal processed using the far-end speech signal, and a second output unit configured to output the speech signal that includes the minimum residual echo amount and is selected by the third selection unit.

With reference to the seventh possible implementation manner of the second aspect, in an eighth possible implementation manner of the second aspect, the output module further includes a detection unit configured to detect whether the near-end speech signal exceeds a specified sound pickup frequency range of the conversation microphone, and further configured to, if it is detected that the near-end speech signal exceeds the specified sound pickup frequency range of the conversation microphone, generate a determining prompt message and send the determining prompt message to a determining unit, and the determining unit configured to, after receiving the determining prompt message sent by the detection unit, determine whether the speech signal that includes the minimum residual echo amount is the speech signal processed using the far-end speech signal, and further configured to, when determining that the speech signal that includes the minimum residual echo amount is the speech signal processed using the far-end speech signal, generate a reselection prompt message and send the reselection prompt message to the third selection unit, where the third selection unit is further configured to, after receiving the reselection prompt message sent by the determining unit, select the echo-canceled speech signal as a specified output speech signal, and further configured to generate a switch prompt message and send the switch prompt message to the second output unit, and the second output unit is further configured to, after receiving the switch prompt message sent by the third selection unit, stop outputting the speech signal that includes the minimum residual echo amount, and output the specified output speech signal selected by the third selection unit.

According to the embodiments of the present disclosure, an echo component in a near-end speech signal is canceled according to a sound signal collected by a collection microphone, and a speech signal with a better echo cancellation effect is output, which can increase accuracy of canceling echo interference, improve an echo cancellation effect, and enhance conversation quality.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic diagram of a circuit principle of an existing echo cancellation method;

FIG. 2 is a flowchart of an echo cancellation method according to an embodiment of the present disclosure;

FIG. 3 is a schematic diagram of structural composition of a communication device according to a first embodiment of the present disclosure;

FIG. 4 is a schematic diagram of structural composition of a communication device according to a second embodiment of the present disclosure;

FIG. 5 is a schematic diagram of structural composition of a communication device according to a third embodiment of the present disclosure;

FIG. 6 is a schematic diagram of structural composition of a communication device according to a fourth embodiment of the present disclosure;

FIG. 7 is a schematic diagram of structural composition of a communication device according to a fifth embodiment of the present disclosure;

FIG. 8 is a schematic diagram of structural composition of a communication device according to a sixth embodiment of the present disclosure;

FIG. 9 is a schematic diagram of structural composition of a communication device according to a seventh embodiment of the present disclosure;

FIG. 10 is a schematic diagram of structural composition of a mobile terminal according to an embodiment of the present disclosure;

FIG. 11 is a schematic diagram of hardware structural composition of a communication device according to a first embodiment of the present disclosure;

FIG. 12 is a schematic diagram of hardware structural composition of a communication device according to a second embodiment of the present disclosure;

FIG. 13 is a schematic diagram of hardware structural composition of a communication device according to a third embodiment of the present disclosure;

FIG. 14 is a schematic diagram of hardware structural composition of a communication device according to a fourth embodiment of the present disclosure;

FIG. 15 is a schematic diagram of composition of a circuit principle of a communication device according to a first embodiment of the present disclosure;

FIG. 16 is a schematic diagram of a composition of a circuit principle of a communication device according to a second embodiment of the present disclosure;

FIG. 17 is a schematic diagram of a composition of a circuit principle of a communication device according to a third embodiment of the present disclosure;

FIG. 18 is a schematic diagram of a composition of a circuit principle of a communication device according to a fourth embodiment of the present disclosure;

FIG. 19 is a schematic diagram of a composition of a circuit principle of a communication device according to a fifth embodiment of the present disclosure; and

FIG. 20 is a schematic diagram of structural composition of a communication system according to an embodiment of the present disclosure.

### DESCRIPTION OF EMBODIMENTS

The following clearly describes the technical solutions in embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

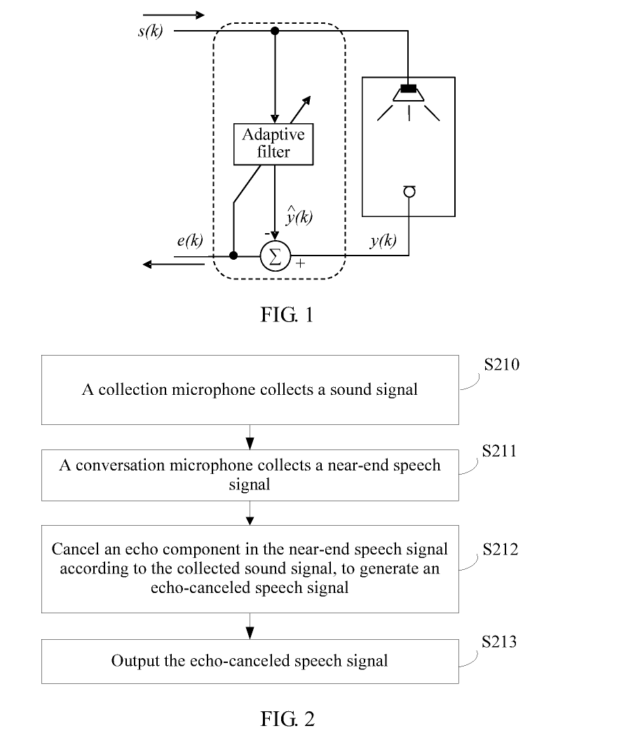

As described above, reference may be together made to a schematic diagram of a circuit principle of an existing echo cancellation method shown in FIG. 1. In the prior art, when echo cancellation is performed, an input of a far-end speech signal that is acquired in a communication process and directly used as a reference echo signal, and another input of a signal collected by a microphone are sent to an adaptive filter for echo cancellation. According to the echo cancellation method and apparatus provided in the embodiments of the present disclosure, a collection microphone collects a sound signal, an echo component in a near-end speech signal collected by a conversation microphone is canceled according to the sound signal, and an echo-canceled speech signal is generated. The sound signal collected by the collection microphone is more similar to the echo component in the near-end speech signal. Echo cancellation performed using the sound signal can increase accuracy of canceling echo interference, improve an echo cancellation effect, and enhance conversation quality.

The collection microphone used to collect the sound signal may be a directional microphone, such as a unidirectional collection microphone or an omnidirectional collection microphone. The directional microphone may be flexibly selected and disposed according to a directionality feature of the directional microphone, to collect a sound signal more similar to the echo component in the near-end speech signal.

Multiple collection microphones may be disposed in same a communication device, and a collection microphone for collecting a sound signal is preferably selected from the multiple collection microphones according to a position at which a user speaks.

Echo cancellation is also correspondingly performed according to the directionality feature of the collection microphone that collects the sound signal. In an echo cancellation process, a filter estimates an analog echo signal using the sound signal. The generated analog echo signal may be infinitely similar to the echo component in the near-end speech signal. The echo component in the near-end speech signal is canceled using the analog echo signal, and a better echo-canceled speech signal can be output.

To ensure quality of an echo-canceled speech signal that is output to a communication peer end, echo cancellation may also be performed in multiple paths, multiple echo-canceled speech signals are generated, and a better speech signal is preferably selected and output to the communication peer end.

Further, optionally, when echo cancellation is performed in multiple paths, in one path, echo cancellation is performed using a far-end speech signal received from a communication peer end, multiple echo-canceled speech signals are generated in the multiple paths, and a better speech signal is preferably selected and output to the communication peer end.

Further, optionally, when there is a path, in which echo cancellation is performed using the far-end speech signal, in the multiple paths, the near-end speech signal is detected. When the near-end speech signal does not meet a specified standard, a speech signal generated after echo cancellation is performed using the far-end speech signal is not selected as a specified output speech signal.

Descriptions are made in the following using specific embodiments.

FIG. 2 is a flowchart of an echo cancellation method according to an embodiment of the present disclosure. The method provided in this embodiment of the present disclosure may be implemented in a communication device. As shown in the figure, a procedure in this embodiment includes the following steps.

Step S210: A collection microphone collects a sound signal. The collection microphone used in this embodiment of the present disclosure is a directional microphone, such as a unidirectional collection microphone or an omnidirectional collection microphone. Compared with a far-end speech signal, the sound signal collected by the collection microphone is more similar to an echo component in a near-end speech signal. Echo cancellation performed using the sound signal collected by the collection microphone effectively increases accuracy of canceling echo interference.

Collection solutions for collecting the sound signal by the collection microphone in this embodiment of the present disclosure may include but are not limited to the following solutions.

Collection solution 1: The sound signal is collected using one unidirectional microphone.

The collection microphone used to collect the sound signal is a unidirectional microphone. The unidirectional collection microphone points to a loudspeaker direction. The collection microphone used in this embodiment of the present disclosure can pick up only a sound emitted by a loudspeaker and reduces interference from another sound such that the collected sound signal is more similar to the echo component in the near-end speech signal. Reference may be together made to a schematic diagram of hardware structural composition shown in FIG. 11. In the figure, Mic-y is a conversation microphone, and a collection microphone Mic1 is disposed near a loudspeaker, where the collection microphone Mic1 is a unidirectional collection microphone and points to a loudspeaker direction. The unidirectional collection microphone is sensitive to a specified direction and can pick up only a sound signal of a specified direction. When the collection microphone Mic1 is disposed in a manner shown in FIG. 11, the collection microphone Mic1 can pick up a sound signal transmitted from a direction on a dotted curve shown in FIG. 11. Therefore, a sound signal x₁(k) used for echo cancellation can be collected using the collection microphone Mic1.

Collection solution 2: The sound signal is collected using at least two collection sub-microphones, where the at least two used collection sub-microphones form one collection sub-microphone assembly, and the collection sub-microphones in the collection sub-microphone assembly are all omnidirectional collection microphones that are arranged in an array manner.

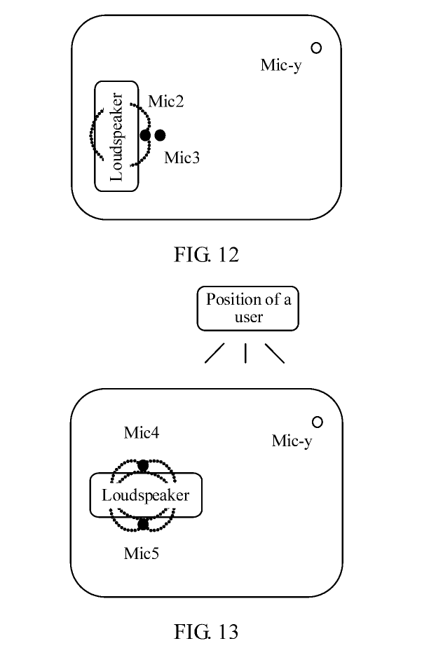

In specific implementation, the omnidirectional collection microphones used in this embodiment of the present disclosure can pick up sounds emitting in all directions and have a same sensitivity to the sounds in all directions. After collecting sound signals, multiple omnidirectional collection microphones may perform calculation according to a beamforming algorithm in order to obtain a sound signal of a specified direction. Reference may be together made to a schematic diagram of hardware structural composition shown in FIG. 12. In the figure, Mic-y is a conversation microphone, and one collection sub-microphone assembly including two collection sub-microphones Mic2 and Mic3 that are arranged in a manner shown in FIG. 12 is located near a loudspeaker. Both the collection sub-microphones Mic2 and Mic3 can pick up sound signals from all directions, two omnidirectional sound signals xₘ₂(k) and xₘ₃(k) are collected using the solution 2.

Collection solution 3: The sound signal is collected using one collection sub-microphone of at least two collection sub-microphones.

The at least two collection sub-microphones used to collect the sound signal are all unidirectional microphones and all point to a loudspeaker direction. In this solution, one collection sub-microphone may be preferably selected to collect the sound signal, and a manner of selecting the collection sub-microphone includes a selecting manner based on a near-end sound source position.

The near-end sound source position in this embodiment of the present disclosure may be considered as a position at which a user that uses the apparatus in the embodiments of the present disclosure speaks. That the sound signal is collected using one collection sub-microphone of at least two collection sub-microphones may include the following steps: acquiring a near-end sound source position, and selecting, from all the collection sub-microphones, a collection sub-microphone closest to the near-end sound source position, to collect the sound signal.

In specific implementation, the near-end sound source position is acquired using multiple methods. A sensor in the communication device may be directly invoked to acquire the near-end sound source position, and for example, the near-end sound source position is acquired in an acoustic wave detecting manner. The methods for acquiring the near-end sound source position are not limited in this embodiment of the present disclosure.

In specific implementation, a function of selecting the collection sub-microphone closest to the near-end sound source position is that using the collection sub-microphone as a collection sub-microphone that picks up the sound signal can effectively avoid that the user makes a voice within a pickup sensitivity range of the collection sub-microphone and avoid that accuracy of picking up the sound signal is reduced. The collection sub-microphone selected in this step may pick up only a sound signal generated by the loudspeaker. A selecting manner may be as follows: according to the acquired near-end sound source position and preset positions of multiple collection sub-microphones, calculating and searching for the collection sub-microphone closest to the near-end sound source position, and selecting the collection sub-microphone as a collection sub-microphone currently used to collect the sound signal. The method for selecting the collection sub-microphone closest to the near-end sound source position is not limited in this embodiment of the present disclosure. Reference may be together made to a schematic diagram of hardware structural composition shown in FIG. 13. In the figure, Mic-y is a conversation microphone, and two collection sub-microphones Mic4 and Mic5 that are arranged in a manner shown in FIG. 13 are disposed near a loudspeaker. Both the collection sub-microphones Mic4 and Mic5 point to the loudspeaker. As shown by a dotted curve in the figure, the collection sub-microphones Mic4 and Mic5 are oppositely disposed at two sides of the loudspeaker. When a user speaks at a position shown in the figure, that is, when the near-end sound source position is the position shown in the figure, the collection sub-microphone Mic4 closest to the near-end sound source position may be found.

In specific implementation, the sound signal is collected using the selected collection sub-microphone. As described in the foregoing example, compared with a sound signal picked up by the collection sub-microphone Mic5 shown in FIG. 13, in a sound signal picked up by the collection sub-microphone Mic4, a quantity of user voices in the collected sound signal can be effectively reduced. A specified direction of the collection sub-microphone Mic5 is similar to a direction of a position at which a user speaks. A user voice may be carried in a process of picking up a sound signal. When echo cancellation is performed using the sound signal picked up by the collection sub-microphone Mic5, the user voice may be canceled. A sound signal x₃(k) used for echo cancellation may be collected by the collection sub-microphone Mic4.

Collection solution 4: The sound signal is collected using one group of collection sub-microphones of at least two groups of collection sub-microphones.

One group of collection sub-microphones may be considered as a collection sub-microphone assembly, and collection sub-microphones in the collection sub-microphone assembly are all omnidirectional collection microphones that are arranged in an array manner.

In specific implementation, the omnidirectional collection microphones used in this embodiment of the present disclosure can pick up sounds emitting in all directions and have a same sensitivity to the sounds in all directions. After collecting sound signals, the multiple omnidirectional collection microphones may perform calculation according to a beamforming algorithm in order to obtain a sound signal of a specified direction. In this solution, one collection sub-microphone assembly may be preferably selected to collect the sound signal, and a manner of selecting the collection sub-microphone assembly includes a selecting manner based on a near-end sound source position.

As described in the foregoing embodiment, the near-end sound source position in this embodiment of the present disclosure may be considered as a position at which a user that uses the apparatus in the embodiments of the present disclosure makes a speaking voice. That the sound signal is collected using one group of collection sub-microphones of at least two groups of collection sub-microphones may include the following steps: acquiring a near-end sound source position, and selecting, from all collection sub-microphone assemblies, a collection sub-microphone assembly closest to the near-end sound source position, to collect the sound signal.

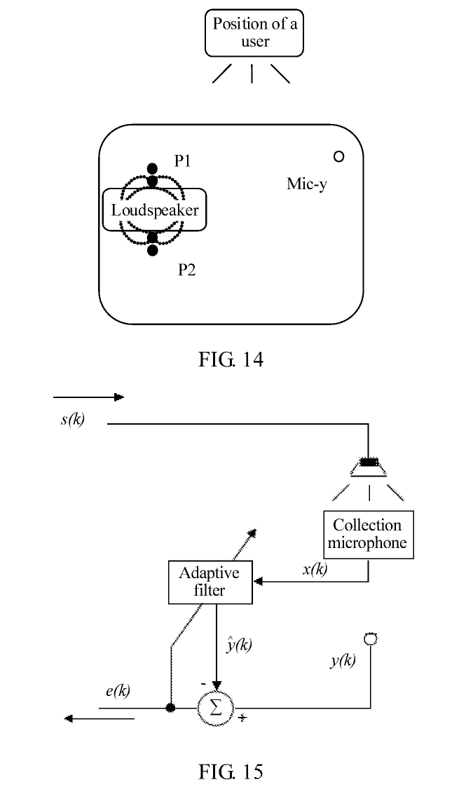

In specific implementation, a function of selecting the collection sub-microphone assembly closest to the near-end sound source position is that using the collection sub-microphone assembly as a collection sub-microphone assembly that picks up the sound signal can effectively reduce interference from a user voice and increase accuracy of acquiring the sound signal. The collection sub-microphone assembly selected in this step can effectively acquire a sound signal generated by the loudspeaker. A selecting manner may be as follows: according to the acquired near-end sound source position and preset positions of multiple collection sub-microphone assemblies, calculating and searching for the collection sub-microphone assembly closest to the near-end sound source position, and selecting the collection sub-microphone assembly as a collection sub-microphone assembly currently used to collect the sound signal. The method for selecting the collection sub-microphone assembly closest to the near-end sound source position is not limited in this embodiment of the present disclosure. Reference may be together made to a schematic diagram of hardware structural composition shown in FIG. 14. In the figure, Mic-y is a conversation microphone, and two collection sub-microphone assemblies P1 and P2 are disposed near a loudspeaker. The collection sub-microphone assemblies P1 and P2 each further include two collection sub-microphones that are arranged in an array manner shown in FIG. 14. The collection sub-microphone assemblies P1 and P2 are oppositely disposed at two sides of the loudspeaker. When a user speaks at a position shown in the figure, that is, when the near-end sound source position is the position shown in the figure, the collection sub-microphone assembly P1 closest to the near-end sound source position may be found.

In specific implementation, the sound signal is collected using the selected collection sub-microphone assembly. As described in the foregoing example, compared with a sound signal picked up by the collection sub-microphone assembly P2 shown in FIG. 14, a sound signal picked up by the collection sub-microphone assembly P1 has a better calculation effect when being used to perform a beamforming calculation. The collection sub-microphone assembly P1 may be used to collect an omnidirectional sound signal X_{P1}(k), where the omnidirectional sound signal X_{P1}(k) includes omnidirectional sound signals collected by all collection sub-microphones in the collection sub-microphone assembly P1.

When the solution 3 or solution 4 is used, if a near-end sound source position acquired in real time changes, and when a reselected collection sub-microphone or collection sub-microphone assembly used to collect the sound signal is different from a current working collection sub-microphone or collection sub-microphone assembly, the collection sub-microphone or the collection sub-microphone assembly used to collect the sound signal needs to be switched to the re-selected collection sub-microphone or collection sub-microphone assembly, to ensure effectiveness of the collected sound signal. In addition, when the collection sub-microphone or the collection sub-microphone assembly needs to be switched, a delay of a time period is required to implement initialization of an echo cancellation software algorithm and initialization of a component, complete signal switching, and ensure quality of an output echo-canceled speech signal and a stable conversation.

Step S211: A conversation microphone collects a near-end speech signal. In the schematic structural diagrams of hardware shown in FIG. 11, FIG. 12, FIG. 13, and FIG. 14, Mic-y in each figure is the conversation microphone mentioned in this embodiment of the present disclosure, and a function of the conversation microphone is to collect the near-end speech signal.

Step S212: Cancel an echo component in the near-end speech signal according to the collected sound signal, to generate an echo-canceled speech signal.

As described in the collection solutions mentioned in the foregoing embodiment, cancellation solutions are also correspondingly provided in this step according to different collection manners, and may include but are not limited to the following solutions.

Cancellation solution 1: A filter performs analog on the echo component in the near-end speech signal according to the collected sound signal, to generate an analog echo signal, and the echo component in the near-end speech signal is canceled using the analog echo signal, to generate an echo-canceled speech signal.

The cancellation solution 1 is applicable to a sound signal collected by a unidirectional microphone, which may include the sound signals collected using the foregoing collection solution 1 and collection solution 3.

In specific implementation, the filter performs analog on the echo component in the near-end speech signal according to the collected sound signal, to generate the analog echo signal. Generating the analog echo signal may be implemented using a calculation method, or may be directly implemented using a component and a related hardware circuit. In a schematic diagram of a circuit principle shown in FIG. 15, a far-end speech signal is s(k), a speech signal that is collected near a loudspeaker and is input into an adaptive filter is x(k), an analog echo signal calculated by the adaptive filter is ŷ(k), a near-end speech signal picked up by the conversation microphone is y(k), and an echo-canceled speech signal used for outputting is e(k). Using the adaptive filter, the sound signal acquired in step S210 is used as a voice model, and echo estimation is performed on the sound signal. A coefficient of the filter is continually modified such that the estimated analog echo signal becomes more similar to the echo component in the near-end speech signal. For example, when the sound signal x₁(k) is collected using the collection solution 1 in step S210, an analog echo signal ŷ₁(k) may be estimated according to the sound signal x₁(k) in this step, and when the sound signal x₃(k) is collected using the collection solution 3 in step S210, an analog echo signal ŷ₃(k) may be estimated according to the sound signal x₃(k) in this step.

In specific implementation, the echo component in the near-end speech signal is canceled using the analog echo signal, to generate the echo-canceled speech signal. In the foregoing example, FIG. 15 is applicable to a communication device shown in FIG. 11. After the sound signal x₁(k) collected by the collection microphone using the collection solution 1 is input into the adaptive filter, the adaptive filter generates the analog echo signal ŷ₁(k), the conversation microphone picks up the near-end speech signal y(k), and in this case, an echo-canceled speech signal e₁(k) is generated after echo cancellation is performed using the method in this embodiment of the present disclosure. In addition, in the foregoing example, FIG. 15 is applicable to a communication device shown in FIG. 13. After the sound signal x₃(k) collected by the collection microphone using the collection solution 3 is input into the adaptive filter, the adaptive filter generates the analog echo signal ŷ₃(k), the conversation microphone picks up the near-end speech signal y(k), and in this case, an echo-canceled speech signal e₃(k) is generated after echo cancellation is performed using the method in this embodiment of the present disclosure.

Cancellation solution 2: A beamforming calculation is performed on the collected sound signal to generate a sound signal of a specified direction. A filter performs analog on the echo component in the near-end speech signal according to the generated sound signal of the specified direction, to generate an analog echo signal, and the echo component in the near-end speech signal is canceled using the analog echo signal, to generate an echo-canceled speech signal.

The cancellation solution 2 is applicable to a sound signal collected by an omnidirectional collection microphone, which may include the sound signals collected using the foregoing collection solution 2 and collection solution 4.

In specific implementation, the beamforming calculation is performed on the collected sound signal, to generate the sound signal of the specified direction. The specified direction is the loudspeaker direction. Multiple omnidirectional collection microphones usually appear together and are arranged in an array manner. The omnidirectional collection microphones can pick up sounds emitting in all directions and has a same sensitivity to the sounds in all directions. In this embodiment of the present disclosure, because a relative position between the loudspeaker and the collection sub-microphone assembly may be determined, the sound signal collected by the collection sub-microphone assembly may be processed according to a beamforming algorithm in order to obtain the sound signal of the specified direction.

In a schematic diagram of a circuit principle shown in FIG. 15, after a communication device shown in FIG. 12 collects two sound signals xₘ₂(k) and xₘ₃(k) using the collection solution 2 in step S210, in this step, the sound signals xₘ₂(k) and xₘ₃(k) collected by the collection sub-microphone assembly are calculated using the beamforming algorithm according to a transfer function in a beamforming system. Parameters in the calculation may include a signal frequency, spacing between the collection microphone Mic2 and the collection microphone Mic3, and the like. A signal transmitted from a direction shown by a dotted curve in FIG. 12 is calculated, and a sound signal x₂(k) of a specified direction is calculated using the transfer function in the beamforming system.

In addition, in the schematic diagram of the circuit principle shown in FIG. 15, after a communication device shown in FIG. 14 collects, in step S210 using the collection solution 4, X_{P1}(k) that includes two sound signals, in this step, the sound signal X_{P1}(k) collected by the collection sub-microphone assembly is calculated using the beamforming algorithm according to the transfer function in the beamforming system. Parameters in the calculation may include a signal frequency, spacing between the two collection sub-microphones in the collection sub-microphone assembly P1, and the like. A signal transmitted from a direction shown by a dotted curve in FIG. 14 is calculated, and a sound signal x₄(k) of a specified direction may be calculated using the transfer function in the beamforming system.

In specific implementation, the filter performs analog on the echo component in the near-end speech signal according to the generated sound signal of the specified direction, to generate the analog echo signal. As described above, in the schematic diagram of the circuit principle shown in FIG. 15, when the sound signal x₂(k) of the specified direction is obtained using the sound signal collected in the collection solution 2 and the foregoing beamforming calculation method, in this step, an analog echo signal ŷ₂(k) may be estimated according to the sound signal x₂(k) of the specified direction; and when the sound signal x₄(k) of the specified direction is obtained using the sound signal collected in the collection solution 4 and the foregoing beamforming calculation method, in this step, an analog echo signal ŷ₄(k) may be estimated according to the sound signal x₄(k) of the specified direction.

In specific implementation, the echo component in the near-end speech signal is canceled using the analog echo signal, to generate the echo-canceled speech signal. In the foregoing example, FIG. 15 is applicable to the communication device shown in FIG. 12. After the sound signal x₂(k) that is of the specified direction and is obtained using the solution 2 and the beamforming calculation method is input into an adaptive filter, the adaptive filter generates the analog echo signal ŷ₂(k), the conversation microphone picks up the near-end speech signal y(k), and in this case, after echo cancellation is performed using a cancellation method 2 in this embodiment of the present disclosure, an echo-canceled speech signal e₂(k) is generated. In addition, in the foregoing example, FIG. 15 is also applicable to the communication device shown in FIG. 14. After the sound signal x₄(k) that is of the specified direction and is obtained using the solution 4 and the beamforming calculation method is input into the adaptive filter, the adaptive filter generates the analog echo signal ŷ₄(k), the conversation microphone picks up the near-end speech signal y(k), and in this case, after echo cancellation is performed using the cancellation method 2 in this embodiment of the present disclosure, an echo-canceled speech signal e₄(k) is generated.

An acoustic echo canceller (AEC) used in this embodiment of the present disclosure may include the adaptive filter. A part of signals input into the AEC may come from the sound signal provided in the foregoing step S210, and the sound signal that is of the specified direction and is obtained using the beamforming algorithm. The adaptive filter has a capability of automatically adjusting a parameter of the adaptive filter, can estimate a required statistical characteristic in a working process, and automatically adjust the parameter of the adaptive filter based on the statistical characteristic, to achieve an optimal filtering effect. Once a statistical characteristic of an input signal changes, the adaptive filter can also monitor the change and automatically adjust the parameter such that optimal performance of the filter can be achieved again. A manner of automatically adjusting the parameter may be considered as an adaptive algorithm, for example, a least mean square (LMS) adaptive algorithmor another derivative algorithm.

Step S213: Output the echo-canceled speech signal. The echo-canceled speech signal generated after the echo component in the near-end speech signal collected by the conversation microphone is canceled in the foregoing step S212 is output in this step.

Further, optionally, when at least two echo-canceled speech signals are generated, this step may be further implemented using the following steps: acquiring a residual echo amount of each of the echo-canceled speech signals, selecting, according to the acquired residual echo amounts of the echo-canceled speech signals, a speech signal that includes a minimum residual echo amount from the echo-canceled speech signals, and outputting the speech signal that includes the minimum residual echo amount.

In this embodiment of the present disclosure, multiple echo cancellation paths may be disposed in the communication device used for echo cancellation, and then an echo-canceled speech signal that has best performance is selected and used as a signal that is output to a far end. Correspondingly, when the multiple echo cancellation paths are disposed in the communication device, multiple echo-canceled speech signals are also generated.

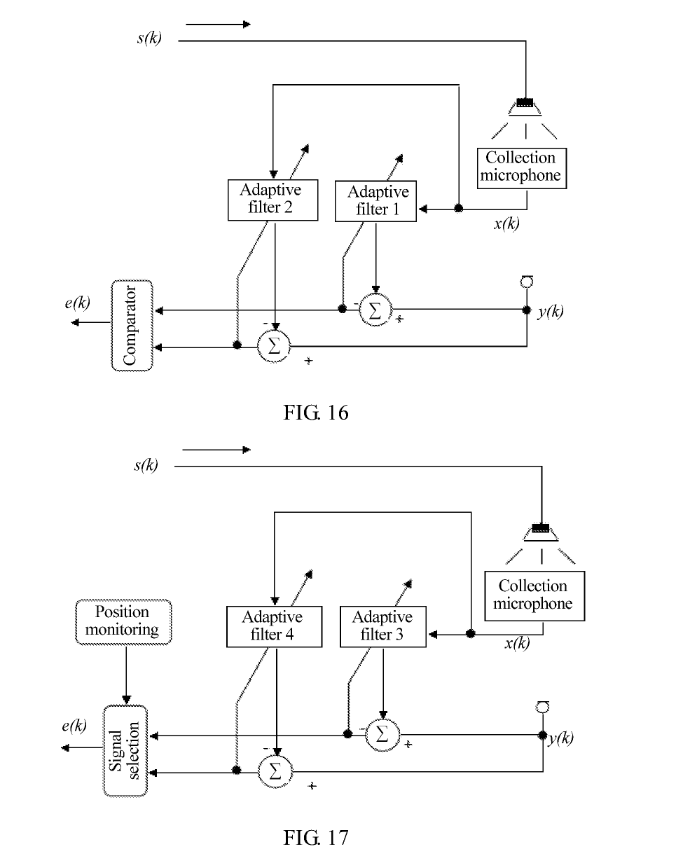

In specific implementation, the residual echo amount of each of the echo-canceled speech signals is acquired. A purpose of acquiring the residual echo amount is to compare performance of the echo-canceled speech signals, and the residual echo amount may be used as a criterion to determine the performance of the echo-canceled speech signals. Reference may be together made to a schematic diagram of a circuit principle shown in FIG. 16. For a hardware arrangement manner of the collection microphone, reference may be made to manners shown in FIG. 11, FIG. 12, FIG. 13, and FIG. 14, or a combination of at least two manners shown in FIG. 11, FIG. 12, FIG. 13, and FIG. 14. The multiple generated echo-canceled speech signals may be input into a comparator, and the residual echo amount of each of the echo-canceled speech signals is acquired using the comparator. For example, at least two signals of multiple echo-canceled speech signals e₁(k), e₂(k), e₃(k), and e₄(k) generated after being collected by the collection microphone and processed using the cancellation solution 1 and the cancellation solution 2 are input into the comparator, and a residual echo amount of each echo-canceled speech signal is acquired.

In specific implementation, the speech signal that includes the minimum residual echo amount is selected from the echo-canceled speech signals according to the acquired residual echo amounts of the echo-canceled speech signals. Performance of the echo-canceled speech signals is measured using multiple methods, which may be not limited to a residual echo amount comparison manner mentioned in this embodiment of the present disclosure. A moving average of residual echoes of all echo-canceled speech signals within a specified time may be determined and used as a parameter for measuring performance of an echo-canceled speech signal.

In specific implementation, the speech signal that includes the minimum residual echo amount is output. In the schematic diagram of the circuit principle shown in FIG. 16, after comparison and selection by the comparator, the speech signal that includes the minimum residual echo amount and is selected by the comparator may be output.

Further, optionally, when the multiple echo cancellation paths in the communication device in this embodiment of the present disclosure are respectively corresponding to collection sub-microphones at multiple positions, a position monitor may be further added for position monitoring, and an echo-canceled speech signal that is output by a preferable echo cancellation path is further selected based on the near-end sound source position. Reference may be together made to a schematic diagram of a circuit principle shown in FIG. 17. In FIG. 17, echo-canceled speech signals that are output by multiple paths are input into a signal selector, and the signal selector selects an output signal using data acquired by the position monitor. The position monitor acquires a near-end sound source position, and an echo-canceled speech signal may be preferably selected according to a generating process of each echo-canceled speech signal. For example, when there are two echo cancellation paths in the communication device, and in the two echo cancellation paths, sound signals is collected using different unidirectional microphones, the signal selector preferably selects, according to the near-end sound source position acquired by the position monitor, an echo cancellation path on which a collection microphone closest to the near-end sound source position is located, and an echo-canceled speech signal that is output by the path is output to a communication peer end.

In addition, when the near-end sound source position changes, the position monitor in the communication device in this embodiment of the present disclosure may detect the change in time, an echo-canceled speech signal that is output by a preferable echo cancellation path is reselected based on a near-end sound source position acquired in real time, and the signal selector is prompted to switch an output signal. In specific implementation, when it is detected that the near-end sound source position changes, and the signal selector needs to switch an output signal, signal switching needs to be completed after a delay of a time period, to ensure quality of the output echo-canceled speech signal and a stable conversation.

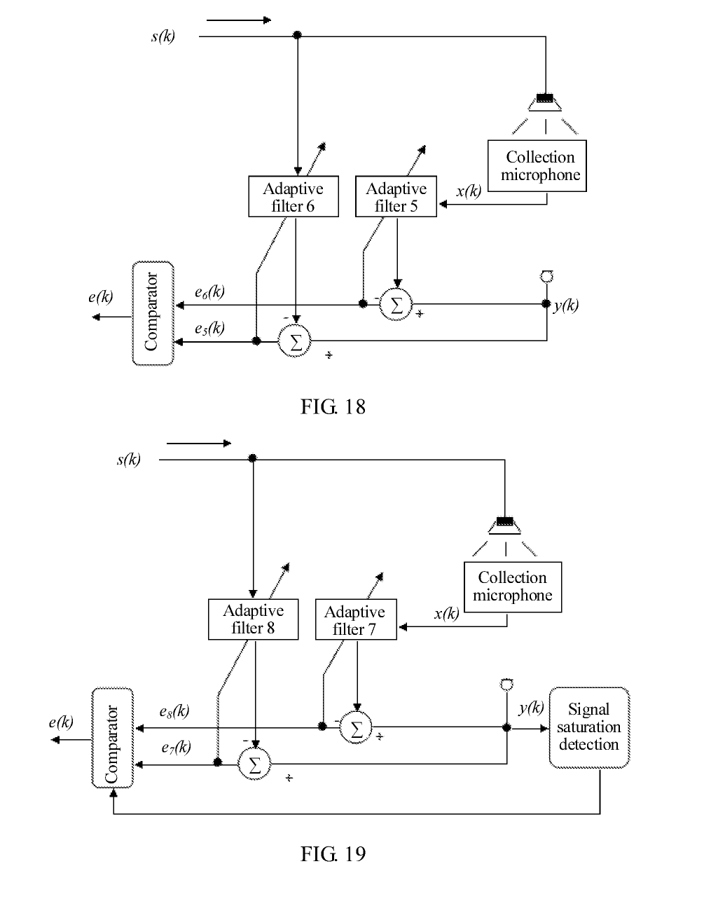

Further, optionally, in the multiple echo cancellation paths in the communication device used in this embodiment of the present disclosure, an echo cancellation path on which a far-end speech signal is used as an input may be further included. A specific implementation manner may include acquiring the far-end speech signal, where the far-end speech signal is a signal received from the communication peer end, canceling the echo component in the near-end speech signal using the far-end speech signal, to generate a speech signal processed using the far-end speech signal. A method for canceling the echo component in the near-end speech signal using the far-end speech signal is the same as a method for canceling the echo component in the near-end speech signal using the sound signal. Reference may be together made to a schematic diagram of a circuit principle shown in FIG. 18. A far-end speech signal s(k) that is input into a loudspeaker is acquired, the far-end speech signal s(k) is input into an adaptive filter 6, then an analog echo signal ŷ₅(k) may be generated by means of estimation, and after an echo component in a near-end speech signal y(k) is canceled using ŷ₅(k), a speech signal e₅(k) processed using the far-end speech signal is generated.

Further, optionally, when the multiple echo cancellation paths in the communication device used in this embodiment of the present disclosure includes the echo cancellation path on which the far-end speech signal is used as an input, the method in this embodiment of the present disclosure may further continue to be further implemented in the following manner. Inputting the echo-canceled speech signal and the speech signal processed using the far-end speech signal into a comparator, acquiring, by the comparator, a residual echo amount of the echo-canceled speech signal and a residual echo amount of the speech signal processed using the far-end speech signal, selecting, according to the acquired residual echo amount of the echo-canceled speech signal and the acquired residual echo amount of the speech signal processed using the far-end speech signal, a speech signal that includes a minimum residual echo amount from the echo-canceled speech signal and the speech signal processed using the far-end speech signal, and outputting the speech signal that includes the minimum residual echo amount.

For specific implementation, reference may be made to the schematic diagram of the circuit principle shown in FIG. 18. It may be learned that a speech signal x(k) collected by the collection microphone is input into an adaptive filter 5, and after the echo component in the near-end speech signal y(k) collected by the collection microphone is canceled using x(k), an echo-canceled speech signal e₆(k) is generated. The acquired far-end speech signal s(k) is input into an adaptive filter 6, and after the echo component in the near-end speech signal y(k) collected by the collection microphone is canceled using s(k), the speech signal e₅(k) processed using the far-end speech signal is generated. The generated echo-canceled speech signal e₆(k) and the generated speech signal e₅(k) processed using the far-end speech signal are input into the comparator for comparison and selection, and the comparator selects the speech signal that includes the minimum residual echo amount from e₅(k) and e₆(k) and outputs the speech signal that includes the minimum residual echo amount. For a method for selecting a signal, reference may be made to the method mentioned in the foregoing embodiment. Details are not repeatedly described herein.

Further, optionally, when the multiple echo cancellation paths in the communication device used in this embodiment of the present disclosure includes the echo cancellation path on which the far-end speech signal is used as an input, the near-end speech signal further needs to be detected, and whether the near-end speech signal meets a specified standard in this embodiment of the present disclosure is determined. When the near-end speech signal does not meet the specified standard, a speech signal generated after echo cancellation is performed using the far-end speech signal is not selected as a specified output speech signal. The following steps may be used for specific implementation: detecting whether the near-end speech signal exceeds a specified sound pickup frequency range of the conversation microphone; if it is detected that the near-end speech signal exceeds the specified sound pickup frequency range of the conversation microphone, determining whether the speech signal that includes the minimum residual echo amount is the speech signal processed using the far-end speech signal; if it is determined that the speech signal that includes the minimum residual echo amount is the speech signal processed using the far-end speech signal, stopping, by the comparator, outputting the speech signal that includes the minimum residual echo amount, and selecting the echo-canceled speech signal as a specified output speech signal, and outputting the specified output speech signal.

In specific implementation, whether the near-end speech signal exceeds the specified sound pickup frequency range of the conversation microphone is detected. Due to a limitation of a hardware structure of the conversation microphone, when a frequency of the near-end speech signal exceeds the sound pickup frequency range of the conversation microphone, compared with a sound at the near-end sound source position, serious distortion may occur in a near-end speech signal actually picked up by the conversation microphone, and the near-end speech signal collected by the conversation microphone is in a saturated state. Multiple reasons cause the near-end speech signal to be in a saturated state. An extremely loud loudspeaker sound or an extremely loud sound at the near-end sound source position may make the near-end speech signal in a saturated state. For example, if a converter that performs analog-to-digital conversion on an analog near-end speech signal picked up by the conversation microphone is at 16-bit quantization level, an amplitude range of a digital speech signal converted by the signal is [−32768, 32767], and a signal exceeding the range is in a saturated state. When it is detected that signal amplitude within a consecutive specified time period gets close to the amplitude values, it is indicates that a current signal is in a saturated state and a nonlinear factor is introduced in a collected signal. Alternatively, two detection intervals may be set, and when it is detected that signal amplitude within a consecutive specified time period is greater than 32000 or is smaller than −32000, a current signal is considered to be in a saturated state and a nonlinear factor is introduced in a collected signal. In this embodiment of the present disclosure, the near-end speech signal is detected in real time. A detection method may be further set according to an actual situation.

When the near-end speech signal exceeds the specified sound pickup frequency range of the conversation microphone, echo cancellation cannot be effectively implemented using the far-end speech signal. Therefore, when it is detected that the near-end speech signal exceeds the specified sound pickup frequency range of the conversation microphone, it needs to determine whether the currently output speech signal that includes the minimum residual echo amount is the speech signal processed using the far-end speech signal.

If it is determined that the speech signal that includes the minimum residual echo amount is the speech signal processed using the far-end speech signal, the comparator stops outputting the speech signal that includes the minimum residual echo amount, selects the echo-canceled speech signal as a specified output speech signal, and outputs the echo-canceled speech signal.

Reference may be together made to a schematic diagram of a circuit principle composition shown in FIG. 19, where a far-end speech signal s(k) is input into an adaptive filter 8, and a sound signal x(k) is collected near a loudspeaker using a collection microphone and is input into an adaptive filter 7. After an echo component in a near-end speech signal y(k) picked up by the conversation microphone is canceled using the far-end speech signal s(k), an echo-canceled speech signal e₇(k) is generated and input into a comparator. After the echo component in the near-end speech signal y(k) picked up by the conversation microphone is canceled using the sound signal x(k), an echo-canceled speech signal e₈(k) is generated and is also input into the comparator. The near-end speech signal y(k) picked up by the conversation microphone is input into a signal saturation detector for signal saturation detection. After detecting that the signal y(k) is in a saturated state, the signal saturation detector prompts the comparator to perform signal determining and determine whether to switch an output signal. For example, when detecting that the signal y(k) is in a saturated state, the signal saturation detector prompts the comparator to perform signal determining and determine whether to switch an output signal. After receiving the prompt, the comparator determines whether a current output speech signal that includes a minimum residual echo amount is the speech signal e₇(k) processed using the far-end speech signal. If it is determined that the current output speech signal that includes the minimum residual echo amount is the speech signal e₇(k) processed using the far-end speech signal, it is considered that outputting the speech signal e₇(k) processed using the far-end speech signal should be stopped, and that the echo-canceled speech signal e₈(k) is selected as a specified output speech signal and is output.

Further, optionally, in a case in which the multiple echo cancellation paths in the communication device used in this embodiment of the present disclosure are at least three echo cancellation paths and the echo cancellation path on which the far-end speech signal is used as an input is included, if it is detected using the signal in the foregoing step that the near-end speech signal exceeds the specified sound pickup frequency range of the conversation microphone, and when the speech signal that includes the minimum residual echo amount and is currently output to the communication peer end is the speech signal processed using the far-end speech signal, a specified output speech signal needs to be reselected from speech signals generated by the multiple echo cancellation paths. When the specified output speech signal is reselected, the echo cancellation path on which the far-end speech signal is used as an input is not selected. For a method for selecting a specified output speech signal, reference may be made to the schematic diagram of the circuit principle shown in FIG. 16 and the foregoing corresponding selecting method.

In addition, to achieve a better effect in this embodiment of the present disclosure, a step of acquiring a near-end sound source position may be added to all the implementation methods mentioned in this embodiment of the present disclosure, and multiple conversation microphones at different positions may be added. When it is detected that the near-end sound source position changes, that is, when a user changes a relative position with the communication device, according to a newly determined near-end sound source position, a conversation microphone close to the new near-end sound source position is automatically selected as a current working conversation microphone, and flexibly selects a collection microphone used to collect a sound signal, to achieve an optimal echo cancellation effect and enhance conversation quality to a greatest extent.

In the method in this embodiment of the present disclosure, the echo cancellation part may be implemented using a hardware apparatus such as an electric component, and for example, a filter used to integrate an adaptive algorithm is disposed in the communication device. Alternatively, echo cancellation may be implemented using software. A sound signal collected by a collection microphone and a near-end speech signal collected by a conversation microphone are used as an input, a related calculation method is integrated in the software, and an operation of canceling an echo component in the near-end speech signal is performed by running a program.

According to the method in this embodiment of the present disclosure, a manner of canceling an echo component in a near-end speech signal is improved, which can avoid a conversation quality impact caused by saturation of a signal collected by a microphone or a play effect difference of a loudspeaker. A collection microphone that includes a directional microphone is disposed near a receiver of the loudspeaker of a communication device, which enhances quality of a collected sound signal used to cancel the echo component in the near-end speech signal. After an echo-canceled speech signal is output, this embodiment of the present disclosure further provides near-end sound source position detection, to ensure that when a relative position between a user and the communication device changes, a preferred solution is automatically switched to for echo cancellation, and after the echo-canceled speech signal is output, this embodiment of the present disclosure further provides signal saturation detection, to ensure conversation quality.

It may be learned from the foregoing description that according to the method in this embodiment of the present disclosure, an echo component in a near-end speech signal is canceled according to a sound signal collected by a collection microphone, and a speech signal with a better echo cancellation effect is output, which increases accuracy of canceling echo interference, improves an echo cancellation effect, and enhances conversation quality.

Correspondingly, an embodiment of the present disclosure provides a communication device configured to implement the foregoing method.

FIG. 3 is a schematic diagram of structural composition of a communication device according to a first embodiment of the present disclosure. The communication device in this embodiment of the present disclosure may be a mobile terminal. As shown in the figure, the communication device in this embodiment of the present disclosure may include at least a first collection module 31, a second collection module 32, a cancellation module 33, and an output module 34.

The first collection module 31 is configured to collect a sound signal using a collection microphone. The collection microphone used in this embodiment of the present disclosure is a directional microphone, such as a unidirectional collection microphone or an omnidirectional collection microphone. Compared with a far-end speech signal, the sound signal collected by the collection microphone is more similar to an echo component in a near-end speech signal. Echo cancellation performed using the sound signal collected by the collection microphone effectively increases accuracy of canceling echo interference.

Further, optionally, collection solutions for collecting the sound signal by the first collection module 31 may include but are not limited to the following solutions.

Collection solution 1: The sound signal is collected using one unidirectional microphone.

Reference may be together made to the schematic diagram of hardware structural composition shown in FIG. 11, where the collection microphone used to collect the sound signal is a unidirectional microphone. The unidirectional collection microphone points to a loudspeaker direction. The collection microphone used in this embodiment of the present disclosure can pick up only a sound emitted by a loudspeaker and reduces interference from another sound such that the collected sound signal is more similar to the echo component in the near-end speech signal.

Collection solution 2: The sound signal is collected using at least two collection sub-microphones. Reference may be together made to the schematic diagram of hardware structural composition shown in FIG. 12, where the at least two used collection sub-microphones form one collection sub-microphone assembly, and the collection sub-microphones in the collection sub-microphone assembly are all omnidirectional collection microphones that are arranged in an array manner.

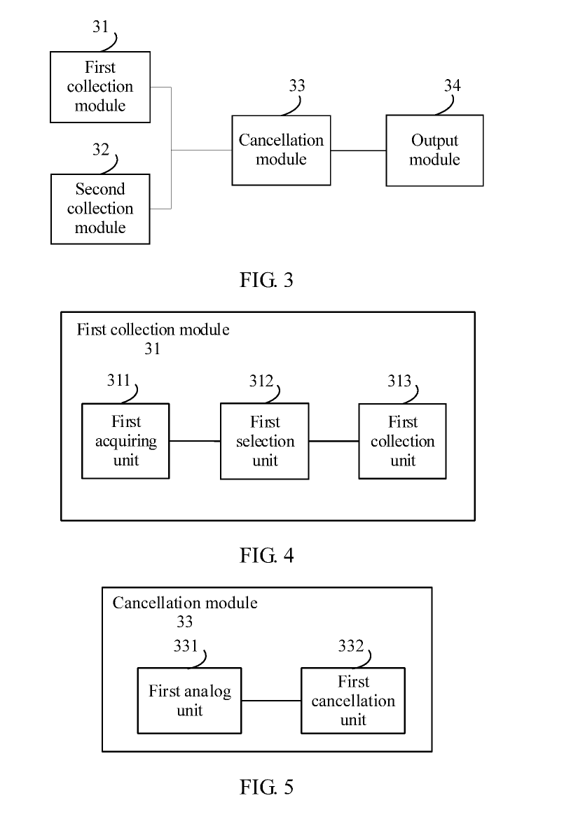

Collection solution 3: The sound signal is collected using one collection sub-microphone of at least two collection sub-microphones. Reference may be together made to a schematic diagram of structural composition of a communication device shown in FIG. 4. As shown in FIG. 4, the first collection module 31 may further include a first acquiring unit 311, a first selection unit 312, and a first collection unit 313.

The first acquiring unit 311 is configured to acquire a near-end sound source position. The near-end sound source position is acquired using multiple methods. A sensor in the communication device may be directly invoked to acquire the near-end sound source position, and for example, the near-end sound source position is acquired in an acoustic wave detecting manner. The methods for acquiring the near-end sound source position by the first acquiring unit 311 are not limited in this embodiment of the present disclosure.

The first selection unit 312 is configured to select, from all the collection sub-microphones, a collection sub-microphone closest to the near-end sound source position acquired by the first acquiring unit 311. A function of selecting the collection sub-microphone closest to the near-end sound source position by the first selection unit 312 is that using the collection sub-microphone as a collection sub-microphone that picks up the sound signal can effectively avoid that a user makes a voice within a pickup sensitivity range of the collection sub-microphone and avoid that accuracy of picking up the sound signal is reduced. The collection sub-microphone selected in this step may pick up only a sound signal generated by the loudspeaker. A selecting manner may be as follows. According to the acquired near-end sound source position and preset positions of multiple collection sub-microphones, calculating and searching for the collection sub-microphone closest to the near-end sound source position, and selecting the collection sub-microphone as a collection sub-microphone currently used to collect the sound signal. The method for selecting the collection sub-microphone closest to the near-end sound source position by the first selection unit 312 is not limited in this embodiment of the present disclosure.

The first collection unit 313 is configured to collect the sound signal using the collection sub-microphone selected by the first selection unit 312. The collection sub-microphone closest to the near-end sound source position is a unidirectional collection microphone.

Collection solution 4: The sound signal is collected using one group of collection sub-microphones of at least two groups of collection sub-microphones. The first acquiring unit 311, the first selection unit 312, and the first collection unit 313 may be used for collection In addition, the collection sub-microphone used by the first collection unit 313 for collection is an omnidirectional collection microphone, and the one group of collection sub-microphones includes at least two omnidirectional collection microphones.

The second collection module 32 is configured to collect a near-end speech signal using a conversation microphone.

The cancellation module 33 is configured to cancel, according to the sound signal collected by the first collection module 31, an echo component in the near-end speech signal collected by the second collection module 32, to generate an echo-canceled speech signal.

Further, optionally, according to different collection manners of the first acquiring module 31, the cancellation module 33 correspondingly provides echo cancellation solutions.

Cancellation solution 1: Reference may be together made to a schematic structural diagram shown in FIG. 5, and as shown in the figure, the cancellation module 33 in this embodiment of the present disclosure may further include a first analog unit 331 and a first cancellation unit 332.

The first analog unit 331 is configured to perform analog on the echo component in the near-end speech signal using a filter according to the sound signal collected by the first collection module 31, to generate an analog echo signal. That the first analog unit 331 generates the analog echo signal may be implemented using a calculation method, or may be directly implemented by a component and a related hardware circuit.

The first cancellation unit 332 is configured to cancel the echo component in the near-end speech signal using the analog echo signal generated by the first analog unit 331, to generate the echo-canceled speech signal.

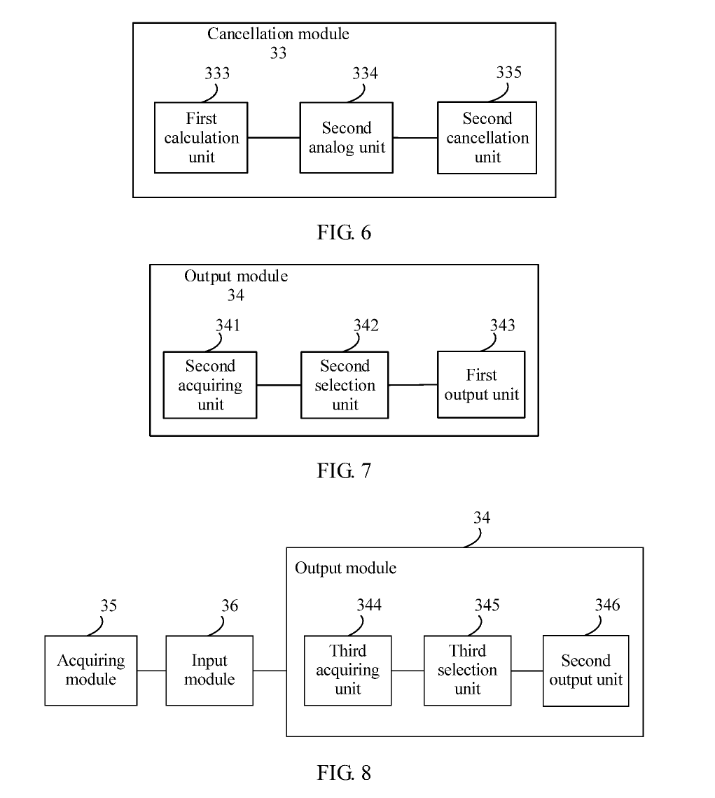

Cancellation solution 2: Reference may be together made to a schematic structural diagram shown in FIG. 6, and as shown in the figure, the cancellation module 33 in this embodiment of the present disclosure may further include a first calculation unit 333, a second analog unit 334, and a second cancellation unit 335.

The first calculation unit 333 is configured to perform a beamforming calculation on the sound signal collected by the first collection module 31, to generate a sound signal of a specified direction, where the sound signal of the specified direction points to a loudspeaker direction. The first calculation unit 333 performs calculation on a sound signal that is collected by the first collection module 31 using an omnidirectional collection microphone, and for a specific calculation method, reference may be made to the foregoing embodiment.

The second analog unit 334 is configured to perform analog on the echo component in the near-end speech signal using a filter according to the sound signal that is of the specified direction and is generated by the first calculation unit 333, to generate an analog echo signal.

The second cancellation unit 335 is configured to cancel the echo component in the near-end speech signal according to the analog echo signal generated by the second analog unit 334, to generate the echo-canceled speech signal.

The output module 34 is configured to output the echo-canceled speech signal generated by the cancellation module 33.

Further, optionally, when the cancellation module 33 generates at least two echo-canceled speech signals, reference may be together made to a structure schematic diagram shown in FIG. 7, and the output module 34 may further include a second acquiring unit 341, a second selection unit 342, and a first output unit 343.

The second acquiring unit 341 is configured to acquire a residual echo amount of each of the echo-canceled speech signals. A purpose of acquiring the residual echo amount is to compare performance of the echo-canceled speech signals, and the residual echo amount may be used as a criterion to determine the performance of the echo-canceled speech signals.

The second selection unit 342 is configured to select, according to the residual echo amounts that are of the echo-canceled speech signals and are acquired by the second acquiring unit 341, a speech signal that includes a minimum residual echo amount from the echo-canceled speech signals.

The first output unit 343 is configured to output the speech signal that includes the minimum residual echo amount and is selected by the second selection unit 342.

Further, optionally, in this embodiment of the present disclosure, the echo component in the near-end speech signal may be canceled using a far-end speech signal received from a communication peer end, which may be implemented using an acquiring module 35, the cancellation module 33, and an input module 36.

The acquiring module 35 is configured to acquire the far-end speech signal. The far-end speech signal is a signal received from the communication peer end.

The cancellation module 33 is further configured to cancel the echo component in the near-end speech signal using the far-end speech signal acquired by the acquiring module 35, to generate a speech signal processed using the far-end speech signal.

Further, optionally, in multiple echo cancellation paths in the communication device used in this embodiment of the present disclosure, an echo cancellation path on which a far-end speech signal is used as an input may be further included. Reference may be together made to a schematic diagram of structural composition shown in FIG. 8. The communication device in this embodiment of the present disclosure may be implemented using an input module 36 and an output module 34.

The input module 36 is configured to input the echo-canceled speech signal and the speech signal processed using the far-end speech signal into a comparator.

The output module 34 includes a third acquiring unit 344 configured to acquire, using the comparator, a residual echo amount of the echo-canceled speech signal and a residual echo amount of the speech signal processed using the far-end speech signal, a third selection unit 345 configured to select, according to the residual echo amount that is of the echo-canceled speech signal and is acquired by the third acquiring unit 344 and the residual echo amount that is of the speech signal processed using the far-end speech signal and is acquired by the third acquiring unit 344, a speech signal that includes a minimum residual echo amount from the echo-canceled speech signal and the speech signal processed using the far-end speech signal, and a second output unit 346 configured to output the speech signal that includes the minimum residual echo amount and is selected by the third selection unit 345.

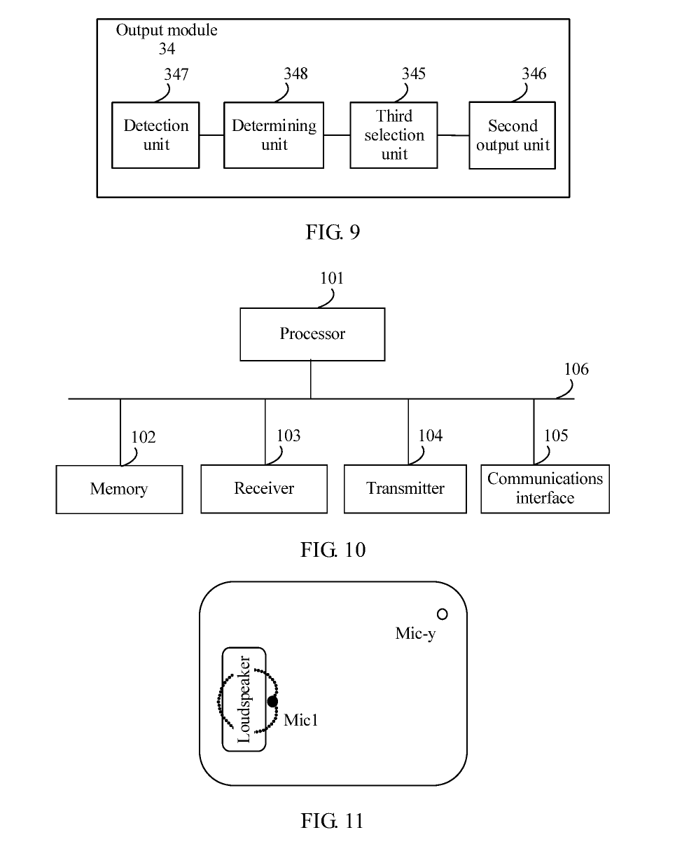

Further, optionally, when the multiple echo cancellation paths in the communication device used in this embodiment of the present disclosure includes the echo cancellation path on which the far-end speech signal is used as an input, reference may be together made to a schematic structural diagram shown in FIG. 9. The output module 34 of the communication device in this embodiment of the present disclosure may further include a detection unit 347, a determining unit 348, the third selection unit 345, and the second output unit 346.

The detection unit 347 is configured to detect whether the near-end speech signal exceeds a specified sound pickup frequency range of the conversation microphone, and further configured to, if it is detected that the near-end speech signal exceeds the specified sound pickup frequency range of the conversation microphone, generate a determining prompt message and send the determining prompt message to the determining unit 348. Due to a limitation of a hardware structure of the conversation microphone, when a frequency of the near-end speech signal exceeds the sound pickup frequency range of the conversation microphone, compared with a sound at the near-end sound source position, serious distortion may occur in a near-end speech signal actually picked up by the conversation microphone. Therefore, echo cancellation cannot be effectively implemented using the far-end speech signal, and it should be detected whether a currently output speech signal that includes a minimum residual echo amount is a speech signal processed using the far-end speech signal.

The determining unit 348 is configured to, after receiving the determining prompt message sent by the detection unit 347, determine whether the speech signal that includes the minimum residual echo amount is the speech signal processed using the far-end speech signal, and further configured to, when determining that the speech signal that includes the minimum residual echo amount is the speech signal processed using the far-end speech signal, generate a reselection prompt message and send the reselection prompt message to the third selection unit 345.

The third selection unit 345 is further configured to, after receiving the reselection prompt message sent by the determining unit 348, select the echo-canceled speech signal as a specified output speech signal, and further configured to generate a switch prompt message and send the switch prompt message to the second output unit 346.

The second output unit 346 is further configured to, after receiving the switch prompt message sent by the third selection unit 345, stop outputting the speech signal that includes the minimum residual echo amount and output the specified output speech signal selected by the third selection unit.

In addition, to achieve a better effect in this embodiment of the present disclosure, multiple conversation microphones at different positions may be added to the communication device in this embodiment of the present disclosure. When it is detected that the near-end sound source position changes, that is, when a user changes a relative position with the communication device, the communication device automatically selects, according to a newly determined near-end sound source position, a conversation microphone close to the new near-end sound source position as a current working conversation microphone, and flexibly selects a collection microphone used to collect a sound signal, to achieve an optimal echo cancellation effect and enhance conversation quality to a greatest extent.

In the communication device in this embodiment of the present disclosure, the cancellation module 33 may implement echo cancellation using a hardware apparatus such as an electric component, and for example, a filter used to integrate an adaptive algorithm is disposed in the communication device. Alternatively, echo cancellation may be implemented using software. A sound signal collected by a collection microphone and a near-end speech signal collected by a conversation microphone are used as an input, a related calculation method is integrated in the software, and an operation of canceling an echo component in the near-end speech signal is performed by running a program.

According to the communication device in this embodiment of the present disclosure, a manner of canceling an echo component in a near-end speech signal is improved, which avoids a conversation quality impact caused by saturation of a signal collected by a microphone or a play effect difference of a loudspeaker, a collection microphone that includes a directional microphone is disposed near a receiver of the loudspeaker, which enhances quality of a collected sound signal used to cancel the echo component in the near-end speech signal. After an echo-canceled speech signal is output, the communication device in this embodiment of the present disclosure further provides near-end sound source position detection, to ensure that when a relative position between a user and the communication device changes, a preferred solution is automatically switched to for echo cancellation, and after the echo-canceled speech signal is output, the communication device in this embodiment of the present disclosure further provides signal saturation detection, to ensure conversation quality.

It may be learned from the foregoing description that according to the communication device in this embodiment of the present disclosure, an echo component in a near-end speech signal is canceled according to a sound signal collected by a collection microphone, and a speech signal with a better echo cancellation effect is output, which increases accuracy of canceling echo interference, improves an echo cancellation effect, and enhances conversation quality.

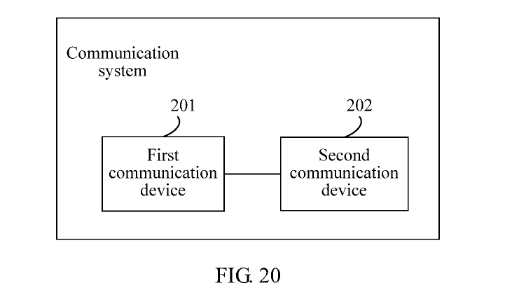

Further, optionally, an embodiment of the present disclosure provides a communication system including two communication devices. Reference may be together made to a schematic diagram of structural composition shown in FIG. 20. The communication system includes a first communication device 201 and a second communication device 202.

The first communication device 201 is an apparatus shown in FIG. 3 to FIG. 9.

The second communication device 202 is the apparatus shown in FIG. 3 to FIG. 9.

FIG. 10 is a schematic diagram of structural composition of a mobile terminal according to an embodiment of the present disclosure. The method shown in FIG. 2 may be implemented in the mobile terminal. The mobile terminal in this embodiment of the present disclosure may include a processor 101, a memory 102, a receiver 103, a transmitter 104, and a communications interface 105.

The receiver 103 is configured to be connected to the processor 101 and configured to receive a far-end speech signal sent by a communication peer end.

The transmitter 104 is configured to be connected to the processor 101 and configured to send an echo-canceled speech signal to the communication peer end, or configured to send a speech signal that includes a minimum residual echo amount to the communication peer end, or configured to send a specified output speech signal to the communication peer end.

The memory 102 is configured to store a cache file in a processing process of the processor 101.

Further, optionally, the mobile terminal in this embodiment of the present disclosure may further include the communications interface 105 that is configured to communicate with an external device. The mobile terminal in this embodiment of the present disclosure may include a bus 106. The processor 101, the memory 102, the receiver 103, and the transmitter 104 may be connected and communicate using the bus. The processor 101 may be a central processing unit (CPU), an application-specific integrated circuit (ASIC), or the like. The memory 102 may include an entity that has a storage function, such as a random access memory (RAM), or a read-only memory (ROM).

According to the mobile terminal in this embodiment of the present disclosure, an echo component in a near-end speech signal is canceled according to a sound signal collected by a collection microphone, and a speech signal with a better echo cancellation effect is output, which increases accuracy of canceling echo interference, improves an echo cancellation effect, and enhances conversation quality.

With descriptions of the foregoing embodiments, a person skilled in the art may clearly understand that the present disclosure may be implemented by hardware, firmware or a combination thereof. When the present disclosure is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible by a computer. The following provides an example but does not impose a limitation. The computer-readable medium may include a RAM, a ROM, an electrically erasable programmable read-only memory (EEPROM), a compact disc read-only memory (CD-ROM), or another optical disc storage or a disk storage medium, or another magnetic storage device, or any other medium that can carry or store expected program code in a form of an instruction or a data structure and can be accessed by a computer. In addition, any connection may be appropriately defined as a computer-readable medium. For example, if software is transmitted from a website, a server or another remote source using a coaxial cable, an optical fiber/cable, a twisted pair, a digital subscriber line (DSL) or wireless technologies such as infrared ray, radio and microwave, the coaxial cable, optical fiber/cable, twisted pair, DSL or wireless technologies such as infrared ray, radio and microwave are included in definition of a medium to which they belong. For example, a disk and disc used by the present disclosure includes a CD, a laser disc, an optical disc, a digital versatile disc (DVD), a floppy disk and a BLU-RAY DISC, where the disk generally copies data by a magnetic means, and the disc copies data optically by a laser means. The foregoing combination should also be included in the protection scope of the computer-readable medium.

What is disclosed above is merely exemplary embodiments of the present disclosure, and certainly is not intended to limit the protection scope of the present disclosure. Therefore, equivalent variations made based on the claims of the present disclosure shall fall within the scope of the present disclosure.

What is claimed is:

1. An echo cancellation method, comprising:
collecting, by a collection microphone, a sound signal;
collecting, by a conversation microphone, a near-end speech signal;
canceling an echo component in the near-end speech signal according to the sound signal, to generate an echo-canceled speech signal; and
outputting the echo-canceled speech signal.

2. The method according to claim 1, wherein the collection microphone is a unidirectional collection microphone, and wherein the unidirectional collection microphone points to a loudspeaker direction.

3. The method according to claim 1, wherein the collection microphone comprises at least two collection sub-microphones, wherein the collection sub-microphones are omnidirectional collection microphones, and wherein the omnidirectional collection microphones are arranged in an array manner.

4. The method according to claim 1, wherein the collection microphone comprises at least two collection sub-microphones, and wherein collecting, by the collection microphone, the sound signal comprises:
acquiring a near-end sound source position; and
selecting, from all the collection sub-microphones, the collection sub-microphone closest to the near-end sound source position, to collect the sound signal, wherein the collection sub-microphone closest to the near-end sound source position is a unidirectional collection microphone or an omnidirectional collection microphone.

5. The method according to claim 1, wherein the collection microphone is a unidirectional microphone, and wherein canceling the echo component in the near-end speech signal according to the sound signal, to generate the echo-canceled speech signal comprises:
performing, by a filter, analog on the echo component in the near-end speech signal according to the sound signal, to generate an analog echo signal; and
canceling the echo component in the near-end speech signal using the analog echo signal, to generate the echo-canceled speech signal.

6. The method according to claim 1, wherein the collection microphone is an omnidirectional collection microphone, and wherein canceling the echo component in the near-end speech signal according to the sound signal, to generate the echo-canceled speech signal comprises:
performing a beamforming calculation on the sound signal to generate a sound signal of a specified direction, wherein the sound signal of the specified direction points to a loudspeaker direction;
performing, by a filter, analog on the echo component in the near-end speech signal according to the sound signal of the specified direction, to generate an analog echo signal; and
canceling the echo component in the near-end speech signal according to the analog echo signal, to generate the echo-canceled speech signal.

7. The method according to claim 1, wherein at least two echo-canceled speech signals are generated, and wherein outputting the echo-canceled speech signal comprises:
acquiring a residual echo amount of each of the echo-canceled speech signals;
selecting, according to the acquired residual echo amounts of the echo-canceled speech signals, a speech signal that comprises a minimum residual echo amount from the echo-canceled speech signals; and
outputting the speech signal that comprises the minimum residual echo amount.

8. The method according to claim 1, wherein after collecting, by the collection microphone, the sound signal, the method further comprises:
acquiring a far-end speech signal, wherein the far-end speech signal is a signal received from a communication peer end; and
canceling the echo component in the near-end speech signal using the far-end speech signal, to generate a speech signal processed using the far-end speech signal,
wherein after outputting the echo-canceled speech signal, the method further comprises:
inputting the echo-canceled speech signal and the speech signal processed using the far-end speech signal into a comparator;
acquiring, by the comparator, a residual echo amount of the echo-canceled speech signal and a residual echo amount of the speech signal processed using the far-end speech signal;
selecting, according to the acquired residual echo amount of the echo-canceled speech signal and the acquired residual echo amount of the speech signal processed using the far-end speech signal, a speech signal that comprises a minimum residual echo amount from the echo-canceled speech signal and the speech signal processed using the far-end speech signal; and
outputting the speech signal that comprises the minimum residual echo amount.

9. The method according to claim 8, wherein outputting the speech signal that comprises the minimum residual echo amount comprises:
detecting whether the near-end speech signal exceeds a specified sound pickup frequency range of the conversation microphone;
determining whether the speech signal that comprises the minimum residual echo amount is the speech signal processed using the far-end speech signal when it is detected that the near-end speech signal exceeds the specified sound pickup frequency range of the conversation microphone;
stopping, by the comparator, outputting the speech signal that comprises the minimum residual echo amount when it is determined that the speech signal that comprises the minimum residual echo amount is the speech signal processed using the far-end speech signal;
selecting the echo-canceled speech signal as a specified output speech signal when it is determined that the speech signal that comprises the minimum residual echo amount is the speech signal processed using the far-end speech signal; and
outputting the specified output speech signal.

10. A communication device, comprising:
a memory; and
a computer processor coupled to the memory, wherein the computer processor is configured to:
collect a sound signal using a collection microphone;
collect a near-end speech signal using a conversation microphone;
cancel, according to the sound signal, an echo component in the near-end speech signal, to generate an echo-canceled speech signal; and
output the generated echo-canceled speech signal.

11. The communication device according to claim 10, wherein the collection microphone is a unidirectional collection microphone, and wherein the unidirectional collection microphone points to a loudspeaker direction.

12. The communication device according to claim 10, wherein the collection microphone comprises at least two collection sub-microphones, wherein the collection sub-microphones are omnidirectional collection microphones, and wherein the omnidirectional collection microphones are arranged in an array manner.

13. The communication device according to claim 10, wherein the collection microphone comprises at least two collection sub-microphones, and wherein the computer processor is further configured to:
acquire a near-end sound source position;
select, from all the collection sub-microphones, the collection sub-microphone closest to the near-end sound source position; and
collect the sound signal using the selected collection sub-microphone, wherein the collection sub-microphone closest to the near-end sound source position is a unidirectional collection microphone or an omnidirectional collection microphone.

14. The communication device according to claim 10, wherein the collection microphone is a unidirectional microphone, and wherein the computer processor is further configured to:
perform analog on the echo component in the near-end speech signal using a filter according to the collected sound signal, to generate an analog echo signal; and
cancel the echo component in the near-end speech signal using the generated analog echo signal, to generate the echo-canceled speech signal.

15. The communication device according to claim 10, wherein the collection microphone is an omnidirectional collection microphone, and wherein the computer processor is further configured to:
perform a beamforming calculation on the collected sound signal, to generate a sound signal of a specified direction, wherein the sound signal of the specified direction points to a loudspeaker direction;
perform analog on the echo component in the near-end speech signal using a filter according to the sound signal that is of the specified direction, to generate an analog echo signal; and
cancel the echo component in the near-end speech signal according to the generated analog echo signal, to generate the echo-canceled speech signal.

16. The communication device according to claim 10, wherein the computer processor is further configured to:
generate at least two echo-canceled speech signals;
acquire a residual echo amount of each of the echo-canceled speech signals;
select, according to the residual echo amounts that are of the acquired echo-canceled speech signals, a speech signal that comprises a minimum residual echo amount from the echo-canceled speech signals; and
output the selected speech signal that comprises the minimum residual echo amount.

17. The communication device according to claim 10, wherein the computer processor is further configured to:
acquire a far-end speech signal, wherein the far-end speech signal is a signal received from a communication peer end;
cancel the echo component in the near-end speech signal using the acquired far-end speech signal, to generate a speech signal processed using the far-end speech signal;
input the echo-canceled speech signal and the speech signal processed using the far-end speech signal into a comparator;
acquire, using the comparator, a residual echo amount of the echo-canceled speech signal and a residual echo amount of the speech signal processed using the far-end speech signal;
select, according to the residual echo amount that is of the acquired echo-canceled speech signal and the residual echo amount that is of the acquired speech signal processed using the far-end speech signal, a speech signal that comprises a minimum residual echo amount from the echo-canceled speech signal and the speech signal processed using the far-end speech signal; and
output the selected speech signal that comprises the minimum residual echo amount.

18. The communication device according to claim 17, wherein the computer processor is further configured to:
detect whether the near-end speech signal exceeds a specified sound pickup frequency range of the conversation microphone;
generate a determining prompt message when it is detected that the near-end speech signal exceeds the specified sound pickup frequency range of the conversation microphone;
determine whether the speech signal that comprises the minimum residual echo amount is the speech signal processed using the far-end speech signal when the determining prompt message is generated;
generate a reselection prompt message when it is determined that the speech signal that comprises the minimum residual echo amount is the speech signal processed using the far-end speech signal;
select the echo-canceled speech signal as a specified output speech signal when the reselection prompt message is generated;
generate a switch prompt message;
stop outputting the speech signal that comprises the minimum residual echo amount when the switch prompt message is generated; and
output the selected specified output speech signal.
